(19) United States
(12) Patent Application Publication
(10) Pub. No.: US 2015/0091206 A1
(43) Pub. Date: Apr. 2, 2015

(54) Method of Resin Molding and System for Resin Molding

(71) Applicant: Yazaki Corporation, Tokyo (JP)

(72) Inventor: Kei Sato, Makinohara-shi (JP)

(73) Assignee: YAZAKI CORPORATION, Tokyo (JP)

(21) Appl. No.: 14/563,384

(22) Filed: Dec. 8, 2014

Related U.S. Application Data
(63) Continuation of application No. PCT/JP2013/066769, filed on Jun. 12, 2013.

(30) Foreign Application Priority Data
Jun. 13, 2012 (JP) 2012-134132

(51) Int. Cl. B29C 45/14; B29C 45/26

(52) U.S. Cl. CPC B29C 45/14065; B29C 45/14819; B29C 45/26; B29C 2045/14131; B29K 2905/00; B29K 2101/00
USPC 264/229; 425/111

(57) ABSTRACT

A terminal fitting includes an electric wire end connecting part that crimps an end portion of an electric wire, and a protruding part that is provided on the electric wire end connecting part. The protruding part interferes with an inner wall which forms a cavity of a main body of a metal mold when the electric wire end connecting part being deformed from an appropriate position is set in the cavity, and corrects the electric wire end connecting part into the appropriate position by a pressing force which occurs due to the interference of the protruding part and the inner wall of the cavity.

### CROSS REFERENCE TO RELATED APPLICATIONS

This application is a continuation of PCT application No. PCT/JP2013/066769, which was filed on Jun. 12, 2013 based on Japanese Patent Application (No. P2012-134132) filed on Jun. 13, 2012, the contents of which are incorporated herein by reference.

### BACKGROUND OF THE INVENTION

1. Field of the Invention

The present invention relates to a method of resin molding an electric wire end connecting part which is formed by crimping an electric wire connecting part that is provided at a rear part of a terminal fitting to an end portion of an electric wire, a system having a metal mold and a terminal fitting used to perform the method.

2. Description of the Related Art

When a terminal fitting is connected to an end portion of an electric wire, it is usual that an electric wire connecting part provided at the rear part of the terminal fitting is crimped to the end portion of the electric wire. When the terminal fitting is crimped to the end portion of the electric wire in this way, an electric wire end connecting part as a crimped part of the terminal fitting is resin molded to ensure corrosion resistance or waterproofness (for example, refer to JP-A-2001-162647). For example, when a copper terminal fitting is crimped to an aluminum electric wire, to prevent electrolytic corrosion in the contact part of different metals, it is preferred that all the part where the terminal fitting is crimped is resin molded to be coated.

FIG. 12A shows the construction of a related terminal fitting for a connector, and FIG. 12B shows that the terminal fitting is crimped to an end portion of an electric wire.

A terminal fitting 10 has an electrical contact part 11 to electrically contact a mating connector terminal at the front part, an electric wire connecting part 16 which is connected to an end portion of an electric wire W at the rear part, and a bridging part 12 between the electrical contact part 11 and the electric wire connecting part 16. The electric wire connecting part 16 has a conductor crimping part 13, which is crimped to a conductor Wa which is exposed by stripping off a sheath Wb of the end portion of the electric wire W, at the front side, a sheath crimping part 15 which is crimped to a part of the sheath Wb at the rear side, and a bridging part 14 between the conductor crimping part 13 and the sheath crimping part 15.

When the terminal fitting 10 is connected to the end portion of the electric wire W, first, an exposed part of the conductor Wa in which the sheath Wb over a predetermined length is stripped off is formed at the end portion of the electric wire W. Then, the exposed part of the conductor Wa is placed on a bottom plate of the conductor crimping part 13, and a part of the conductor Wa with the sheath Wb is placed on a bottom plate of the sheath crimping part 15. By using a crimping device, the conductor crimping part 13 is crimped to the conductor Wa of the electric wire W and the sheath crimping part 15 is crimped to the part of the conductor Wa with the sheath Wb. Thereby, the terminal fitting 10 can be connected to the end portion of the electric wire W.

Then, when an electric wire end connecting part 16A that is a connection part between the end portion of the electric wire W and the terminal fitting 10 is resin molded, the terminal fitting 10 is set in a metal mold 1 for resin molding, as shown in FIG. 12C. An accommodating space 4 to accommodate the terminal fitting 10 is formed in the metal mold 1 by combining an upper metal mold 2 and a lower metal mold 3. A cavity 6 into which resin is injected is ensured at the rear of the accommodating space 4 when the rear of the accommodating space 4 is partitioned off by a partition wall 5. When the terminal fitting 10 is set, the electric wire end connecting part 16 is accommodated in the cavity 6. The electric wire end connecting part 16A can be coated with resin by injecting molding resin from a gate 7 formed on the upper metal mold 2. Because it is necessary to draw the electric wire W connected to the terminal fitting 10 outside the metal mold 1, an electric wire drawing hole 8 is formed at one end of the cavity 6.

### SUMMARY OF THE INVENTION

When the terminal fitting 10 is crimped to the end portion of the electric wire W, deformations such as an upwards/downwards bend (curve of an angle θ1) may occur between the front part and the rear part of the terminal fitting 10 as shown in FIG. 13A or a leftward/rightward bend (curve of an angle θ2) may occur between the front part and the rear part of the terminal fitting 10 as shown in FIG. 14A. When these deformations greatly occur, as shown in FIGS. 13B and 14B, in the stage when the terminal fitting 10 is set in the metal mold 1, the electric wire end connecting part 16A may interfere with an inner wall of the cavity 6, and the thickness of the resin to be coated on the electric wire end connecting part 16A cannot be ensured to a required quantity. In particular, when an interference occurs due to the bending of the terminal fitting 10, because the interference position is uncertain and unpredictable, it is difficult to manage the resin thickness.

For example, in a resin molded part 20 formed as illustrated in FIG. 13C, it is possible that a necessary resin thickness cannot be ensured in the area shown with a symbol A, and quality of the resin molded part 20 may not be stabilized.

The present disclosure is made in view of the circumstances, and the object of the present disclosure is to provide a resin molding method of resin molding an electric wire end connecting part, a metal mold which is used to perform the resin molding method and a terminal fitting so that even if there are deformations such as the bending in the terminal fitting, the resin thickness of a resin molded part can be managed appropriately.

The above object of the present disclosure is accomplished by the following constructions.

There is provided a method of resin molding comprising:
setting an electric wire end connecting part of a terminal fitting which crimps an end portion of an electric wire in a cavity of a main body of a metal mold, wherein a protruding part is provided on at least one of a first part of the electric wire end connecting part and a second part of an inner wall which forms the cavity of the main body, the first part and the second part are faced to each other;
interfering with one of the first part or the second part by the protruding part provided on the other of the first part or the second part when the electric wire end connecting part being deformed from an appropriate position is set in the cavity;
correcting the electric wire connecting part into the appropriate position by a pressing force which occurs due to the interference of the protruding part; and
injecting molding resin into the cavity to coat the corrected electric wire end connecting part.

There is provided a metal mold for resin molding, comprising:
a main body that includes a cavity to which an electric wire end connecting part of a terminal fitting which crimps an end portion of an electric wire is to be set; and
a protruding part that is provided on an inner wall which forms the cavity of the main body, interferes with the electric wire end connecting part when the electric wire end connecting part being deformed from an appropriate position is set in the cavity, and corrects the electric wire end connecting part into the appropriate position by a pressing force which occurs due to the interference of the protruding part and the electric wire end connecting part.

There is provided a terminal fitting comprising:
an electric wire end connecting part that crimps an end portion of an electric wire; and
a protruding part that is provided on the electric wire end connecting part, interferes with an inner wall which forms a cavity of a main body of a metal mold when the electric wire end connecting part being deformed from an appropriate position is set in the cavity, and corrects the electric wire end connecting part into the appropriate position by a pressing force which occurs due to the interference of the protruding part and the inner wall of the cavity.

For example, the electric wire end connecting part includes: a conductor crimping part which crimps an exposed conductor of the electric wire; a sheath crimping part which crimps a sheath part of the electric wire; and a bridging part which connects the conductor crimping part and the sheath crimping part; and the protruding part is provided on the conductor crimping part.

For example, the electric wire end connecting part includes: a conductor crimping part which crimps an exposed conductor of the electric wire; a sheath crimping part which crimps a sheath part of the electric wire; and a bridging part which connects the conductor crimping part and the sheath crimping part, the bridging part has a pair of side walls, and the protruding part has protruding pieces which are provided on the pair of side walls respectively.

For example, the electric wire end connecting part includes: a conductor crimping part which crimps an exposed conductor of the electric wire; a sheath crimping part which crimps a sheath part of the electric wire; and a bridging part which connects the conductor crimping part and the sheath crimping part, and the protruding part is provided on the sheath crimping part.

According to the above method of resin molding the electric wire end connecting part, even if the electric wire end connecting part of the terminal fitting is deformed from an appropriate position, because the electric wire end connecting part is corrected to the appropriate position with a pressing force that occurs since the protruding part provided on the metal mold or the terminal fitting interferes with the mating part, and the molding resin is formed in this state, the resin will not become too thin at an uncertain position, the electric wire end connecting part can be coated with resin of an appropriate thickness, and the resin thickness can be easily managed. If the metal mold is provided with the protruding part, although a hole is formed at a position of the resin that corresponds to the protruding part, because the position of the hole is managed beforehand, the corrosion resistance will not be influenced.

According to the above metal mold, because the protruding part is provided on the metal mold, the electric wire end connecting part can be coated with resin of an appropriate thickness without changing the shape of the terminal fitting, even if the electric wire end connecting part of the terminal fitting is deformed from an appropriate position.

According to the above terminal fitting, because the protruding part is provided on the terminal fitting, the electric wire end connecting part can be coated with resin of an appropriate thickness without changing the shape of the metal mold, even if the electric wire end connecting part of the terminal fitting is deformed from an appropriate position.

With the present disclosure, even if the electric wire end connecting part of the terminal fitting is deformed from an appropriate position, an electric wire end connecting part can be coated with resin of an appropriate thickness, and the resin thickness can be easily managed.

The present disclosure has been briefly described above. Further, details of the present disclosure will become more apparent after embodiments of the invention described below (hereinafter referred to as “embodiments”) are read with reference to the accompanying figures.

### BRIEF DESCRIPTION OF THE DRAWINGS

FIG. 1 is an illustrative figure of a resin molding method of a first embodiment of the present disclosure, and is a side sectional view which shows that a terminal fitting is set in a metal mold to resin mold an electric wire end connecting part.

FIG. 2 is a perspective view of the terminal fitting after a resin molded part is formed by using the resin molding method of the first embodiment.

FIG. 3 is an illustrative figure of a resin molding method of a second embodiment of the present disclosure, and is a side sectional view which shows that a terminal fitting is set in a metal mold to resin mold an electric wire end connecting part.

FIG. 4 is an illustrative figure of a resin molding method of a third embodiment of the present disclosure, and is a side sectional view which shows that a terminal fitting is set in a metal mold to resin mold an electric wire end connecting part.

FIG. 5 is an illustrative figure of a resin molding method of a fourth embodiment of the present disclosure, and is a top view which shows that a terminal fitting is set in a metal mold to resin mold an electric wire end connecting part.

FIG. 6 is a perspective view of the terminal fitting after a resin molded part is formed by using the resin molding method of the fourth embodiment.

FIGS. 7A to 7C are illustrative figures of a resin molding method of a fifth embodiment of the present disclosure, in which FIG. 7A is a perspective view which shows a state that a terminal fitting is crimped to an end portion of an electric wire, FIG. 7B is a side view which shows the same state that the terminal fitting is crimped to the end portion of an electric wire, and FIG. 7C is a side sectional view which shows that the terminal fitting is set in a metal mold to resin mold an electric wire end connecting part.

FIGS. 8A to 8C are illustrative figures of a resin molding method of a sixth embodiment of the present disclosure, in which FIG. 8A is a perspective view which shows a state that a terminal fitting is crimped to an end portion of an electric wire, FIG. 8B is a side view which shows the same state that the terminal fitting is crimped to the end portion of an electric wire, and FIG. 8C is a side sectional view which shows that the terminal fitting is set in a metal mold to resin mold an electric wire end connecting part.

FIGS. 9A to 9E are illustrative figures of a resin molding method of a seventh embodiment of the present disclosure, in which FIG. 9A is a perspective view which shows a state that a terminal fitting is crimped to an end portion of an electric wire, FIG. 9B is a side view which shows the same state that the terminal fitting is crimped to the end portion of the electric wire, FIG. 9C is a side sectional view which shows that the terminal fitting is set in a metal mold to resin mold an electric wire end connecting part, FIG. 9D is an enlarged perspective view of main parts of FIG. 9A, and FIG. 9E is a perspective view which show a variation of the same parts of FIG. 9D.

FIGS. 10A and 10B are illustrative figures of a resin molding method of an eighth embodiment of the present disclosure, in which FIG. 10A is a perspective view which shows that a terminal fitting is crimped to an end portion of an electric wire, and FIG. 10B is a top view which shows that the terminal fitting is set in a metal mold to resin mold an electric wire end connecting part.

FIG. 11 is an illustrative figure of a resin molding method of a ninth embodiment of the present disclosure, and is a perspective view which shows that a terminal fitting is crimped to an end portion of an electric wire.

FIGS. 12A to 12C are illustrative figures of a traditional example, in which FIG. 12A is a perspective view which shows the construction of a traditional, typical terminal fitting for a connector, FIG. 12B is a perspective view which shows that the same terminal fitting is crimped to an end portion of an electric wire, and FIG. 12C is a side sectional view which shows that the terminal fitting is set in a metal mold to resin mold an electric wire end connecting part.

FIGS. 13A to 13C are illustrative figures when an upward/downward bend occurs in the terminal fitting, in which FIG. 13A is a side view of the terminal fitting, FIG. 13B is a side sectional view which shows that the terminal fitting is set in a metal mold, and FIG. 13C is a side view of the terminal fitting after a resin molded part is formed.

FIGS. 14A and 14B are illustrative figures when a leftward/rightward bend occurs in the terminal fitting, in which FIG. 14A is a top view of the terminal fitting, and FIG. 14B is a top view which shows that the terminal fitting is set in a metal mold.

### DETAILED DESCRIPTION OF THE EXEMPLARY EMBODIMENTS

Next, embodiments of the present disclosure are described with reference to the figures.

### First Embodiment

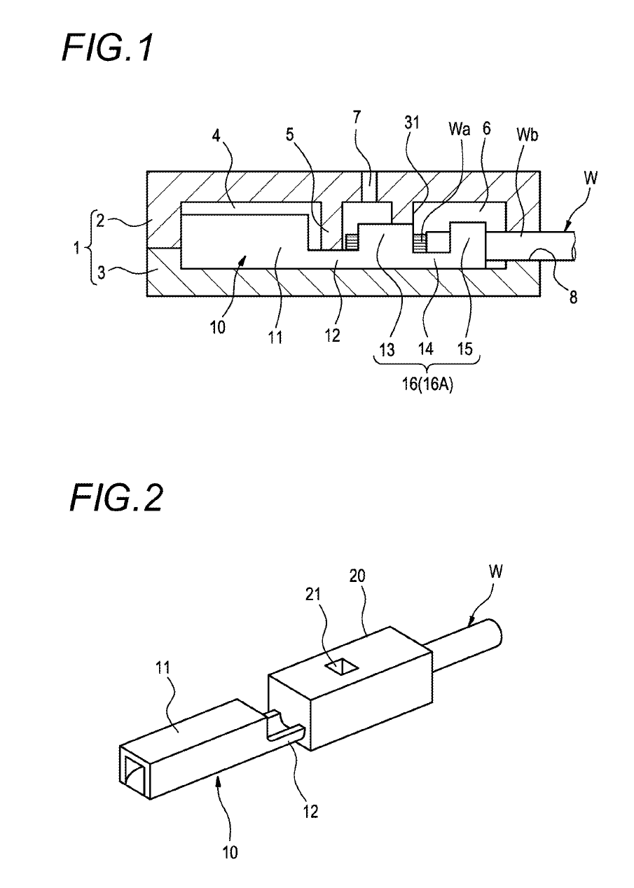

FIG. 1 is an illustrative figure of a resin molding method of the first embodiment, and is a side sectional view which shows that a terminal fitting is set in a metal mold to resin mold an electric wire end connecting part. FIG. 2 is a perspective view of the terminal fitting after a resin molded part is formed.

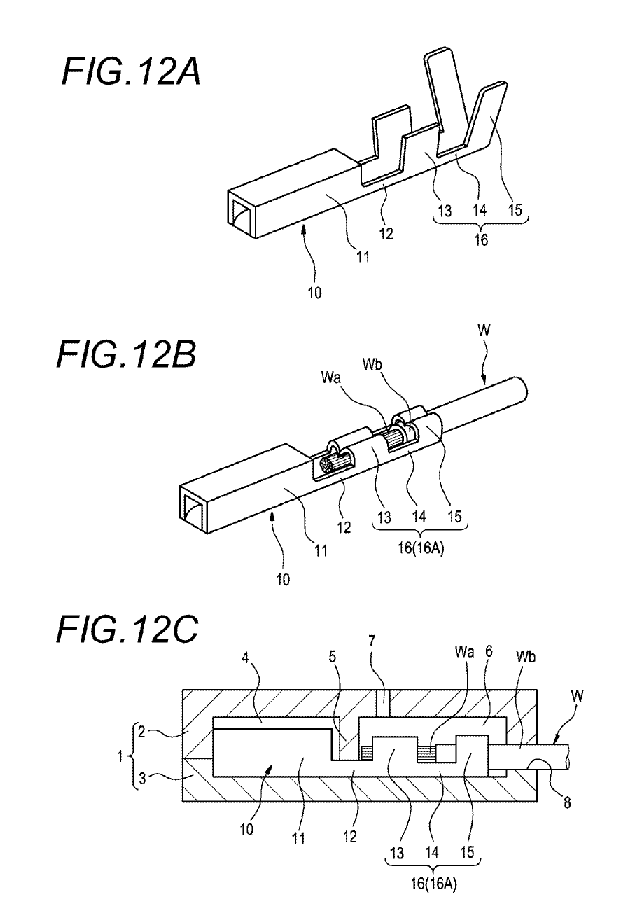

A terminal fitting 10 which is the same as that shown in FIG. 12A is used in the resin molding method of the first embodiment. As shown in FIG. 1, the terminal fitting 10 has an electrical contact part 11 to electrically contact a mating connector terminal at the front part, an electric wire connecting part 16 which is connected to an end portion of an electric wire W at the rear part, and a bridging part 12 arranged between the electrical contact part 11 and the electric wire connecting part 16. The electric wire connecting part 16 has a conductor crimping part 13, which is crimped to a conductor Wa which is exposed by stripping off a sheath Wb of the end portion of the electric wire W, at the front side, a sheath crimping part 15 which is crimped to part of the sheath Wb at the rear side, and a bridging part 14 between the conductor crimping part 13 and the sheath crimping part 15.

When the terminal fitting 10 is connected to the end portion of the electric wire W, first, an exposed part of the conductor Wa in which the sheath Wb over a predetermined length is stripped off is formed at the end portion of the electric wire W. Then, the exposed part of the conductor Wa is placed on a bottom plate of the conductor crimping part 13, and a part of the conductor Wa with the sheath Wb (the part of the conductor Wa is not exposed from the sheath Wb) is placed on a bottom plate of the sheath crimping part 15. By using a crimping device, the conductor crimping part 13 is crimped to the conductor Wa of the electric wire W and the sheath crimping part 15 is crimped to the sheath Wb. Thereby, the terminal fitting 10 can be connected to the end portion of the electric wire W.

Then, when an electric wire end connecting part 16A which connects the end portion of the electric wire W with the terminal fitting 10 is resin molded, the terminal fitting 10 is set in a metal mold 1 for resin molding, as shown in FIG. 1. An accommodating space 4 to accommodate the terminal fitting 10 is formed in the metal mold 1 by combining an upper metal mold 2 and a lower metal mold 3, and a cavity 6 into which resin is injected is ensured at the rear of the accommodating space 4 when the rear of the accommodating space 4 is partitioned off by a partition wall 5. When the terminal fitting 10 is set, the electric wire end connecting part 16A is accommodated in the cavity 6, and the bridging part 12 of the terminal fitting 10 is pressed down with the partition wall 5. The bridging part 12 is positioned at a border portion between the electrical contact part 11 at the front part of the terminal fitting 10 and the electric wire connecting part 16 at the rear part of the terminal fitting 10. Therefore, the electrical contact part 11 at the front part of the terminal fitting 10 is maintained in the predetermined position.

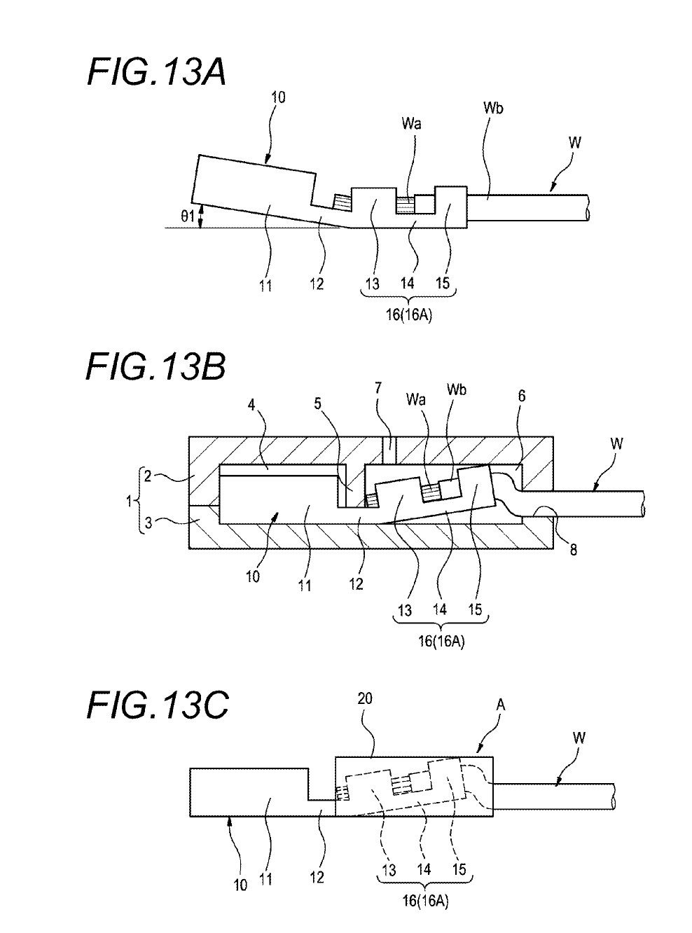

The inner wall of the cavity 6 of the upper metal mold 2 is provided with a protruding part 31. The protruding part 31 interferes with the conductor crimping part 13 of the electric wire connecting part 16 and corrects the electric wire connecting part 16 into an appropriate position (appropriate shape) with a pressing force that occurs due to the interference, when the electric wire end connecting part 16A is set in the cavity 6 in a state that the electric wire connecting part 16 is deformed from the appropriate position, that is, in the present embodiment, in a state that as shown in FIG. 13A, the electric wire connecting part 16 at the rear part is bent upward relative to the electrical contact part 11 of the terminal fitting 10 at the front part. Therefore, when the upper metal mold 2 closely covers the lower metal mold 3, the protruding part 31 provided on the upper metal mold 2 presses down the electric wire connecting part 16 of the terminal fitting 10 so that the electric wire connecting part 16 can be corrected to the appropriate position. In this state, by inserting molding resin from the gate 7 into the cavity 6, the electric wire end connecting part 16A can be coated with the molding resin.

As described above, even if the electric wire connecting part 16 of the terminal fitting 10 deforms upwards and/or downward from the appropriate position thereof, because the electric wire connecting part 16 is corrected to the appropriate position with a pressing force of the protruding part 31 because the protruding part 31 provided on the metal mold 1 interferes with the electric wire connecting part 16 of the terminal fitting 10, the formed resin will not become too thin at an uncertain position, the electric wire end connecting part 16A can be coated with resin of an appropriate thickness, and the resin thickness can be easily managed. As shown in FIG. 2, although a hole 21 is formed in the formed resin molded part 20 at a position which corresponds to the position where the protruding part 31 is provided. Because the position of the hole 21 can be a position that is managed beforehand, the corrosion resistance will not be influenced due to the hole 21.

### Second Embodiment and Third Embodiment

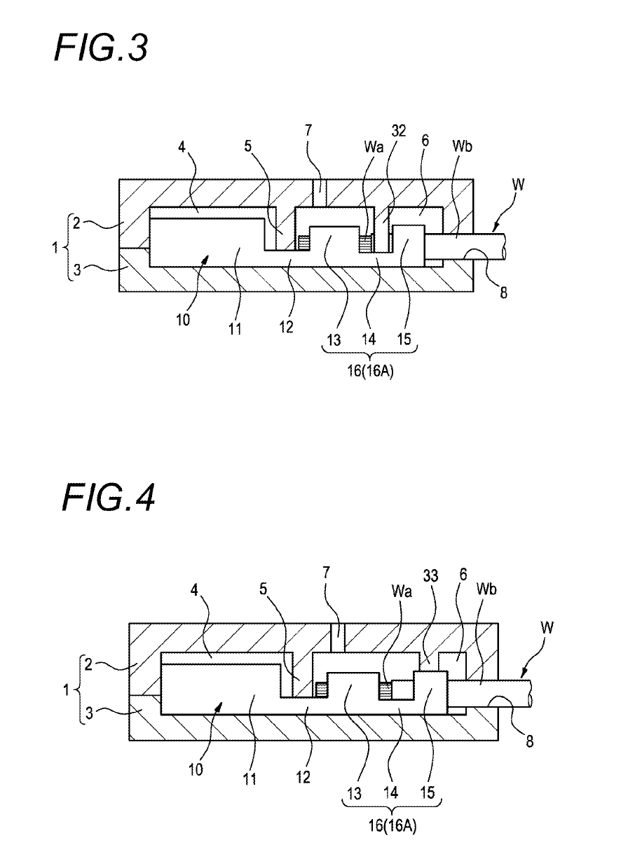

In the first embodiment, the upper metal mold 2 has the protruding part 31 to interfere with the conductor crimping part 13 of the electric wire connecting part 16, but it is also possible that the upper metal mold 2 has a protruding part 32 at a position where the bridging part 14 of the electric wire connecting part 16 is interfered with the protruding part 21, as in the second embodiment shown in FIG. 3. Also, it is possible that the upper metal mold 2 has a protruding part 33 to interfere with the sheath crimping part 15 of the electric wire connecting part 16, as in the third embodiment shown in FIG. 4.

### Fourth Embodiment

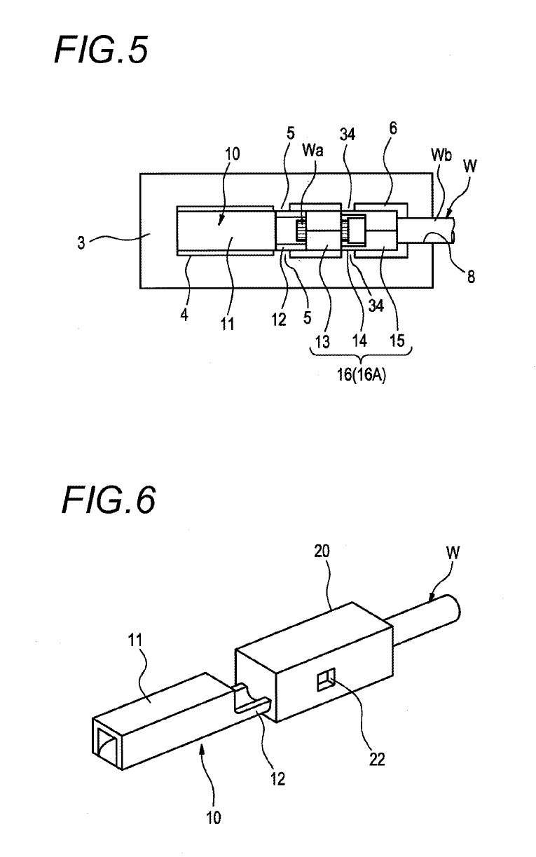

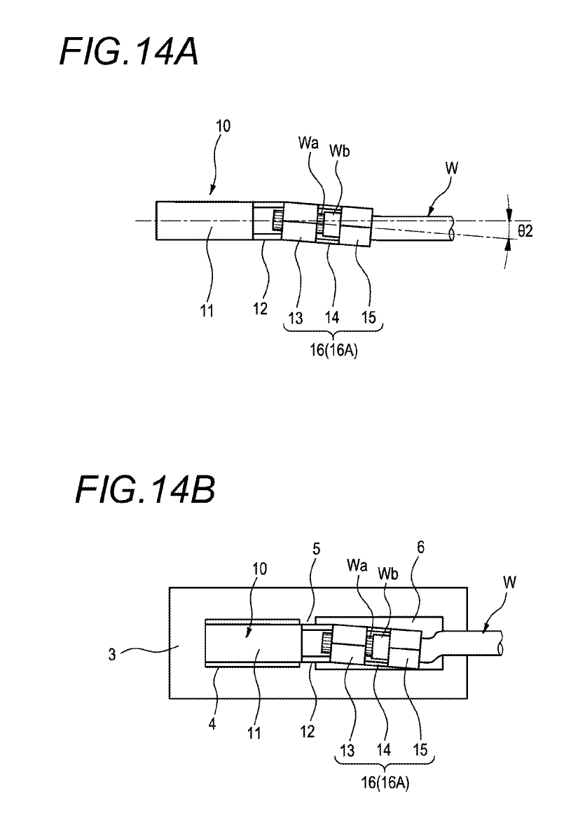

In the first to the third embodiments described above, a coping method when the terminal fitting 10 is bent upward/downward is described, but the method of this fourth embodiment is a coping method when the electric wire connecting part 16 at the rear part of the terminal fitting 10 is bent leftward and/or rightward relative to the electrical contact part 11 at the front part of the terminal fitting 10 as shown in FIG. 14A. As shown in FIG. 5, two side walls of the lower metal mold 3 in the accommodating space 4 are provided with partition walls 5 which press down the bridging part 12 located at the border between the front part and the rear part of the terminal fitting 10 to maintain positions and define the front end of the cavity 6.

The right and left inner side walls of the cavity 6 are provided with protruding parts 34 which interfere with the electric wire connecting part 16 and correct the electric wire connecting part 16 into an appropriate position (appropriate form) with a pressing force that occurs due to the interference, when the electric wire end connecting part 16A is set in the cavity 6 in a state that the electric wire connecting part 16 is deformed from an appropriate position, that is, in the present embodiment, in a state that as shown in FIG. 14A, the electric wire connecting part 16 at the rear part is bent leftward and/or rightward relative to the electrical contact part 11 of the terminal fitting 10 at the front part. Therefore, when the electric wire connecting part 16 is accommodated in the cavity 6 of the lower metal mold 3, the electric wire connecting part 16 can be corrected into the appropriate position by the protruding parts 34. When the upper metal mold 2 closely covers the lower metal mold 3 in this state and molding resin is inserted from the gate 7 into the cavity 6, the electric wire end connecting part 16A is coated with the molding resin.

In this case, when the electric wire connecting part 16 of the terminal fitting 10 deforms leftward and/or rightward from an appropriate position (appropriate form), because the electric wire connecting part 16 is corrected to the appropriate position with a pressing force that occurs since the protruding parts 34 provided on the metal mold 1 interfere with the electric wire end connecting part 16A of the terminal fitting 10, the resin will not become too thin at an uncertain position, the electric wire end connecting part 16A can be coated with resin of an appropriate thickness, and the resin thickness can be easily managed. As shown in FIG. 6, although holes 22 are formed at positions of the formed resin molded part 20 which correspond to the positions where the protruding parts 34 are provided, because the positions of the holes 22 can be positions that are managed beforehand, the corrosion resistance will not be influenced.

### Fifth Embodiment

In the first to the fourth embodiments described above, it is described that the protruding parts 31 to 34 to correct the deformation of the terminal fitting 10 are provided on the metal mold 1, but the same effects can be obtained even if protruding parts to correct the deformation are provided on the terminal fitting 10.

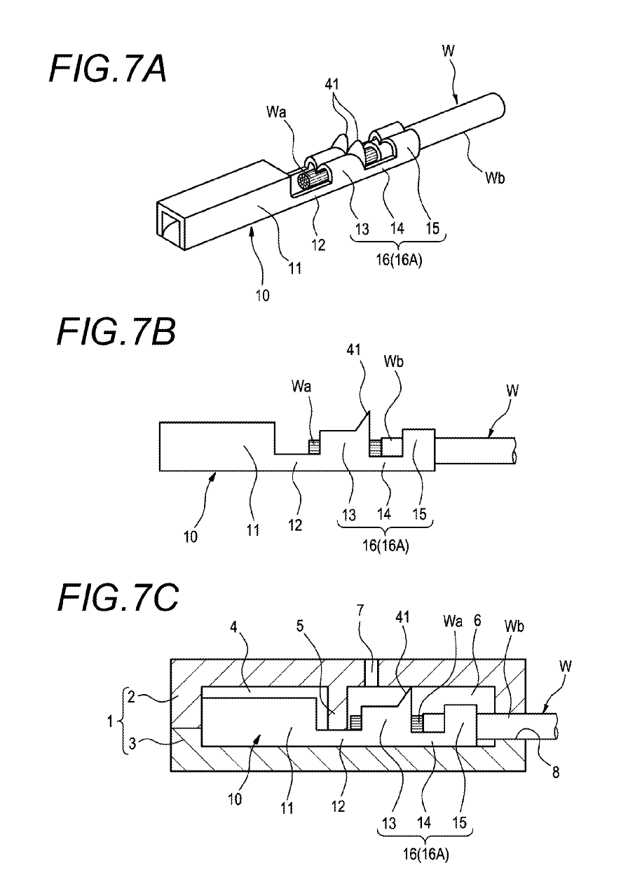

In the fifth embodiment shown in FIGS. 7A to 7C, as shown in FIGS. 7A and 7B, the rear end of the conductor crimping part 13 of the terminal fitting 10 is provided with protruding parts 41 which are rising pieces. When the terminal fitting 10 has the protruding parts 41 in this way, as shown in FIG. 7C, when the terminal fitting 10 in a state of being bent upwards and/or downwards is set in the metal mold 1, the deformation of the electric wire connecting part 16 of the terminal fitting 10 is corrected because the protruding parts 41 interfere with the inner wall of the cavity 6 and a pressing force of the inner wall of the cavity 6 applying to the protruding parts 41 occurs. Therefore, like the first embodiment, by injecting molding resin from the gate 7 into the cavity 6, the electric wire end connecting part 16A can be coated with the molding resin of a predetermined thickness.

### Sixth Embodiment and Seventh Embodiment

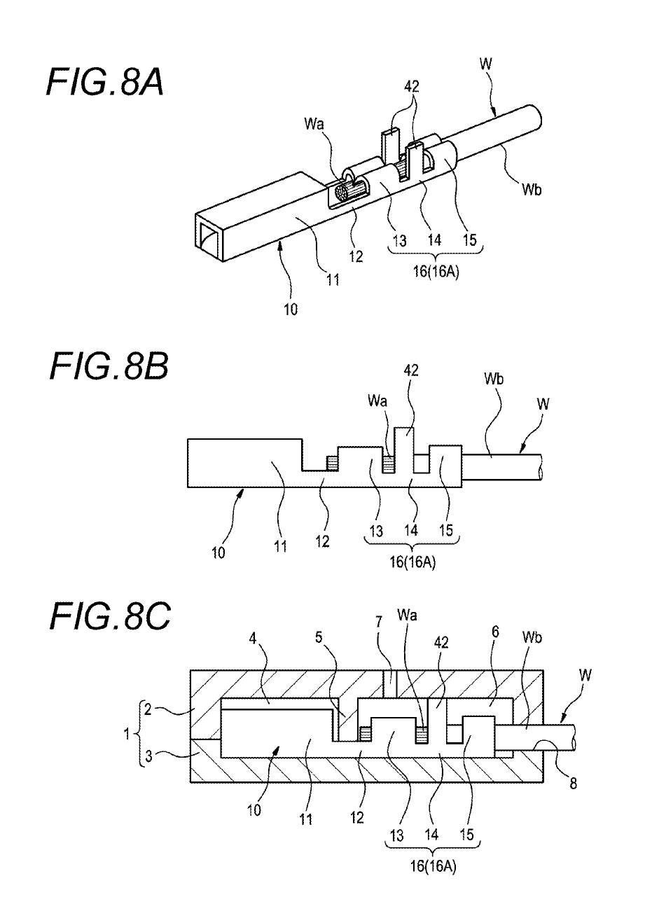

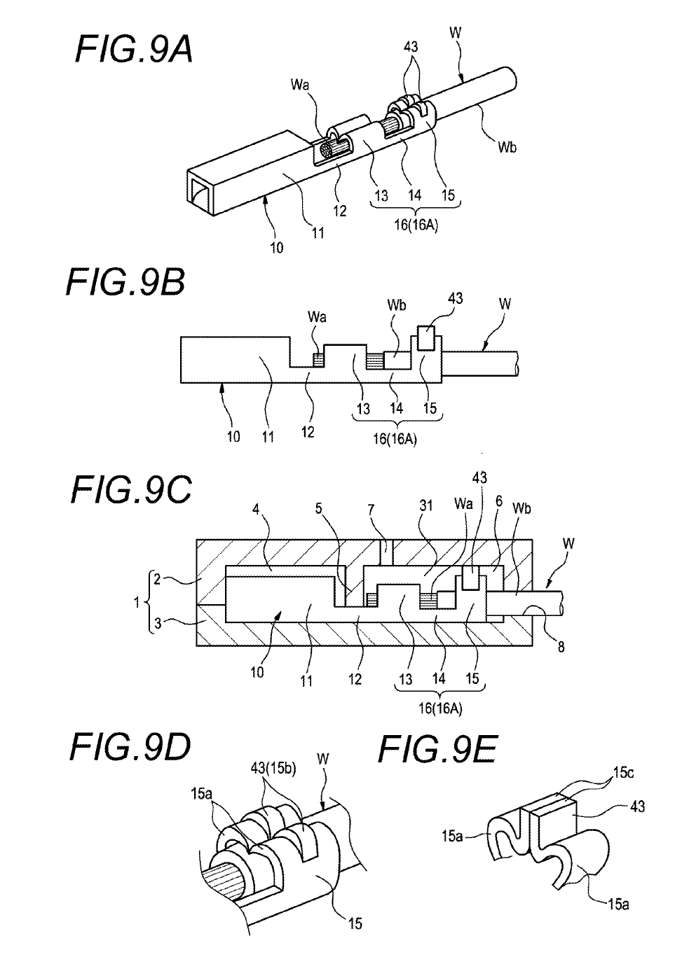

In the fifth embodiment, it is shown that the conductor crimping part 13 of the electric wire connecting part 16 has the protruding parts 41, but it is also possible that the bridging part 14 between the conductor crimping part 13 and the sheath crimping part 15 of the electric wire connecting part 16 has protruding parts (protruding pieces) 42, as in the sixth embodiment shown in FIGS. 8A to 8C. Also, it is also possible that the sheath crimping part 15 of the electric wire connecting part 16 has protruding parts 43, as in the seventh embodiment shown in FIGS. 9A to 9C. When the sheath crimping part 15 has the protruding parts 43, it is possible that crimped pieces 15a which form the sheath crimping part 15 have bulging projections 15b which are the protruding parts 43, as shown in FIG. 9D, and it is possible that the joint portions of the crimped pieces 15a which form the sheath crimping part 15 are protruded as upwards rising pieces 15c which are the protruding parts 43, as shown in FIG. 9E.

### Eighth Embodiment and Ninth Embodiment

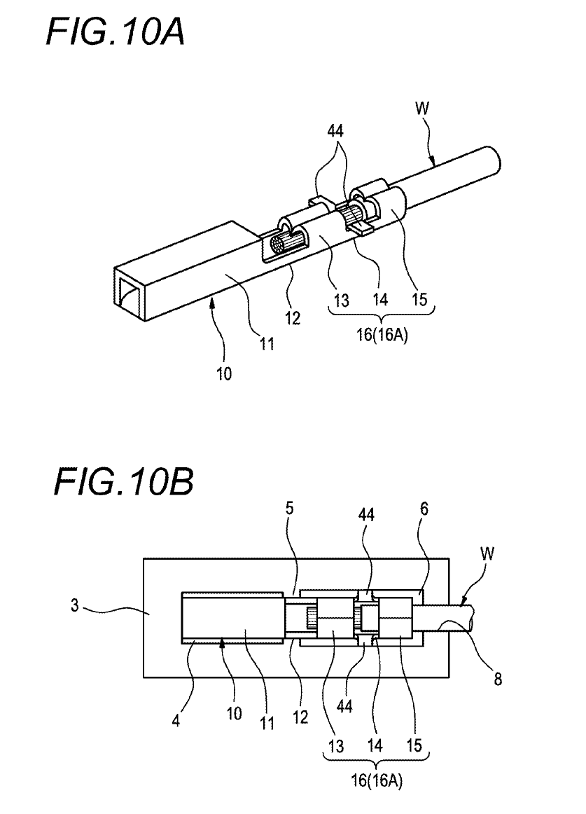

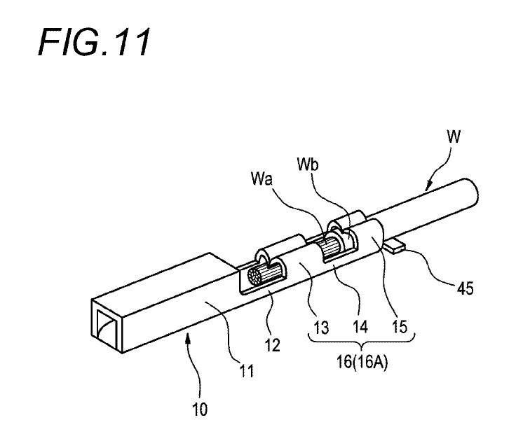

In the eighth embodiment shown in FIGS. 10A and 10B, to cope with a case that the electric wire connecting part 16 of the terminal fitting 10 is bent leftward and/or rightward, the bridging part 14 of the electric wire connecting part 16 of the terminal fitting 10 is formed with protruding parts 44 laterally. In the ninth embodiment shown in FIG. 11, the sheath crimping part 15 of the electric wire connecting part 16 of the terminal fitting 10 is formed with protruding parts 45 laterally. In these cases, because the protruding parts 44 interfere with internal side walls of the cavity 6 when the terminal fitting 10 is set in the metal mold 1, deformation of the terminal fitting 10 can be corrected and the resin mold of a predetermined thickness can be formed.

The present disclosure is not restricted to the above-described embodiments, and suitable modifications, improvements and the like can be made. Moreover, the materials, shapes, dimensions, numbers, installation places, and the like of the components in the above embodiment are arbitrarily set as far as the invention can be attained, and not particularly restricted.

The features of the embodiments of a method of resin molding, a metal mold for resin molding and a terminal fitting concerning the present disclosure are collectively listed briefly in the following [1] to [5], respectively.

[1] A method of resin molding comprising:
setting an electric wire end connecting part (16) of a terminal fitting (10) which crimps an end portion of an electric wire (W) in a cavity (6) of a main body of a metal mold (1), wherein a protruding part (31-34, 41-44) is provided on at least one of a first part of the electric wire end connecting part (16) and a second part of an inner wall which forms the cavity (6) of the main body, the first part and the second part are faced to each other;
interfering with one of the first part or the second part by the protruding part (31-34, 41-44) provided on the other of the first part or the second part when the electric wire end connecting part (16) being deformed from an appropriate position (appropriate form) is set in the cavity (6);
correcting the electric wire connecting part into the appropriate position by a pressing force which occurs due to the interference of the protruding part; and
injecting molding resin into the cavity (6) to coat the corrected electric wire end connecting part (16).

[2] A metal mold (1) for resin molding, comprising:
a main body that includes a cavity (6) to which an electric wire end connecting part (16) of a terminal fitting (10) which crimps an end portion of an electric wire is to be set; and
a protruding part (31-34) that is provided on an inner wall which forms the cavity (6) of the main body, interferes with the electric wire end connecting part (16) when the electric wire end connecting part (16) being deformed from an appropriate position (appropriate form) is set in the cavity (6), and corrects the electric wire connecting part into the appropriate position by a pressing force which occurs due to the interference of the protruding part (31-34) and the electric wire end connecting part (16).

[3] A terminal fitting (10) comprising:
an electric wire connecting part that crimps an end portion of an electric wire; and
a protruding part (41-44) that is provided on the electric wire end connecting part (16), interferes with an inner wall which forms a cavity (6) of a main body of a metal mold (1) when the electric wire end connecting part (16) being deformed from an appropriate position (appropriate form) is set in the cavity (6), and corrects the electric wire connecting part into the appropriate position by a pressing force which occurs due to the interference of the protruding part (41-44) and the inner wall of the cavity (6).

[4] For example, the electric wire end connecting part (16) includes: a conductor crimping part (13) which crimps an exposed conductor of the electric wire; a sheath crimping part (15) which crimps a sheath part of the electric wire; and a bridging part (14) which connects the conductor crimping part (13) and the sheath crimping part (15), and the protruding part is provided on the conductor crimping part (13).

[5] For example, the electric wire end connecting part (16) includes: a conductor crimping part (13) which crimps an exposed conductor of the electric wire; a sheath crimping part (15) which crimps a sheath part of the electric wire; and a bridging part (14) which connects the conductor crimping part (13) and the sheath crimping part (15), the bridging part (14) has a pair of side walls, and the protruding part has protruding pieces which are provided on the pair of side walls respectively.

[6] For example, the electric wire end connecting part (16) includes: a conductor crimping part (13) which crimps an exposed conductor of the electric wire; a sheath crimping part (15) which crimps a sheath part of the electric wire; and a bridging part (14) which connects the conductor crimping part (13) and the sheath crimping part (15), and the protruding part is provided on the sheath crimping part (15).

By the present disclosure, even if an electric wire connecting part of a terminal fitting is deformed from an appropriate position (appropriate form), an electric wire end connecting part of the terminal fitting can be coated with resin of an appropriate thickness, and the resin thickness can be easily managed.

What is claimed is:

1. A method of resin molding comprising:
setting an electric wire end connecting part of a terminal fitting which crimps an end portion of an electric wire in a cavity of a main body of a metal mold, wherein the main body of the metal mold has an upper metal mold and a lower metal mold, the cavity of the main body is formed by combining the upper metal mold and the lower metal mold to each other, and wherein a protruding part is provided on at least one of a first part of the electric wire end connecting part and a second part of an inner wall which forms the cavity of the main body, the first part and the second part are faced to each other;
interfering with one of the first part or the second part by the protruding part provided on the other of the first part or the second part when the electric wire end connecting part being deformed from an appropriate position is set in the cavity;
correcting the electric wire end connecting part into the appropriate position by a pressing force which occurs due to the interference of the protruding part when the upper metal mold is combined with the lower metal mold; and
injecting molding resin into the cavity to coat the corrected electric wire end connecting part.

2. A system for resin molding, comprising:
a metal mold for resin molding; and
a terminal fitting having an electric wire end connecting part which crimps an end portion of an electric wire,
wherein a main body of the metal mold has an upper metal mold and a lower metal mold, and a cavity of the main body is formed by combining the upper metal mold and the lower metal mold to each other;
wherein a protruding part is provided on one of an inner wall of the cavity of the main body and the electric wire end connecting part; and
wherein the protruding part interferes with the other of the inner wall of the cavity of the main body and the electric wire end connecting part and corrects the electric wire end connecting part into an appropriate position by a pressing force which occurs due to the interference of the protruding part and the other of the inner wall of the cavity of the main body and the electric wire end connecting part, when the electric wire end connecting part being deformed from the appropriate position is set in the cavity and the upper metal mold is combined with the lower metal mold.

3. The system for resin molding according to claim 2, wherein the electric wire end connecting part includes:
a conductor crimping part which crimps an exposed conductor of the electric wire;
a sheath crimping part which crimps a sheath part of the electric wire; and
a bridging part which connects the conductor crimping part and the sheath crimping part; and
wherein the protruding part is provided on the conductor crimping part.

4. The system for resin molding according to claim 2, wherein the electric wire end connecting part includes:
a conductor crimping part which crimps an exposed conductor of the electric wire;
a sheath crimping part which crimps a sheath part of the electric wire; and
a bridging part which connects the conductor crimping part and the sheath crimping part;
wherein the bridging part has a pair of side walls; and
wherein the protruding part has protruding pieces which are provided on the pair of side walls respectively.

5. The system for resin molding according to claim 2, wherein the electric wire end connecting part includes:
a conductor crimping part which crimps an exposed conductor of the electric wire;
a sheath crimping part which crimps a sheath part of the electric wire; and
a bridging part which connects the conductor crimping part and the sheath crimping part; and
wherein the protruding part is provided on the sheath crimping part.
